(19) United States
(12) Patent Application Publication
(10) Pub. No.: US 2024/0223926 A1
(43) Pub. Date: Jul. 4, 2024

(54) OPTICAL COMMUNICATION SYSTEM, CONTROL CIRCUIT, AND OPTICAL COMMUNICATION METHOD

(71) Applicant: Mitsubishi Electric Corporation, Tokyo (JP)

(72) Inventor: Satoshi YOSHIMA, Tokyo (JP)

(73) Assignee: Mitsubishi Electric Corporation, Tokyo (JP)

(21) Appl. No.: 18/609,436

(22) Filed: Mar. 19, 2024

Related U.S. Application Data
(63) Continuation of application No. PCT/JP2021/043476, filed on Nov. 26, 2021.

(51) Int. Cl. H04Q 11/00

(52) U.S. Cl. CPC H04Q 11/0062; H04Q 2011/0086

(57) ABSTRACT

An optical communication system includes: a plurality of optical transmitters, a plurality of optical couplers, a plurality of optical receivers, and a control unit that controls operations of the plurality of optical transmitters and the plurality of optical receivers. Each of the plurality of optical transmitters allocates a communication resource to a signal to be transmitted so as to prevent the signal to be transmitted from colliding with a packet signal as an optical signal to be transmitted from another optical transmitter on the basis of a first control signal, and transmits a plurality of packet signals.

### CROSS-REFERENCE TO RELATED APPLICATION

This application is a continuation application of International Application PCT/JP2021/043476, filed on Nov. 26, 2021, and designating the U.S., the entire contents of which are incorporated herein by reference.

### BACKGROUND OF THE INVENTION

### 1. Field of the Invention

The present disclosure relates to an optical communication system for performing optical communication, a control circuit, and an optical communication method.

### 2. Description of the Related Art

As a switch device capable of performing switching between a plurality of input ports and a plurality of output ports, Japanese Translation of PCT International Application Laid-open No. 2021-503193 discloses a configuration including 1:N switches on an input side and N:1 switches on an output side. In the configuration, a signal input to an input port is switched to any output port of a 1:N switch. Thereafter, on a side of the output ports, selection is performed by an N:1 switch so as to extract a signal only from an input port determined in advance by an external control device, and the signal is extracted from an output port.

Japanese Translation of PCT International Application Laid-open No. 2021-503193 also discloses a method using 1:N power dividers instead of 1:N switches on the input side and a method using N:1 power combiners instead of N:1 switches on the output side. The power dividers and the power combiners may be realized by active elements, but can also be realized by passive elements. In a case where the power dividers and the power combiners are realized by the passive elements, from the viewpoint that power is not consumed by the passive elements, a method using 1:N power dividers and N:1 power combiners can reduce power consumption as compared with a method using 1:N switches and N:1 switches.

Japanese Patent No. 6656466 discloses a configuration in which memories that store data are held in input/output ports, and a plurality of switching modules are disposed in a lattice pattern, thereby enabling switching from any input port to any output port with low delay. The configuration has an advantage that a digital signal can be switched with as low delay as possible.

WO2021/009869 discloses a configuration in which signals in a multiple access state on a wavelength axis and a time axis are coupled/branched by using optical couplers in an optical fiber transmission line, and switched from any input node to any output node. The configuration has an advantage that a switching function can also be realized while sufficiently utilizing the broadband property of optical fibers.

Japanese Translation of PCT International Application Laid-open No. 2021-503193 discloses a switch device including a 1:N switch or an N:1 switch, or a 1:N switch and an N:1 switch in a case of realizing a switching function. Since these switches are active elements requiring an external power supply, in the above switch device, power consumption increases and reliability decreases, which is problematic.

Furthermore, the switch device described in Japanese Translation of PCT International Application Laid-open No. 2021-503193 is a switch device to be used in a bent-pipe satellite that performs switching without digitizing a high-frequency signal input thereto. Therefore, the switch device described in Japanese Translation of PCT International Application Laid-open No. 2021-503193 also has a problem that the device including peripheral devices such as power supply installations is increased in size.

The switch device described in Japanese Patent No. 6656466 digitizes a high-frequency signal input thereto by using an analog-to-digital converter (ADC) and performs switching. Therefore, the switch device described in Japanese Patent No. 6656466 has an advantage from the viewpoint of increase in the size of the device, but has a problem that power consumption increases due to a switch function using a highly integrated electronic circuit such as an application specific integrated circuit (ASIC) or a field-programmable gate array (FPGA). Highly integrated electronic circuits are inferior to passive elements from the viewpoint of reliability, which is problematic.

In the switch device described in WO2021/009869, there is the following disadvantage: since signals of all transmission nodes are aggregated into one optical fiber and propagated, a band per signal is more limited with increasing number of signals being multiplexed, that is, a switching capacitance has to be limited not to exceed a signal capacitance available for transmission by one optical fiber.

### SUMMARY OF THE INVENTION

In order to solve the above-described problems and achieve the object, an optical communication system according to the present disclosure includes: a plurality of optical transmission devices, each of which converting a first data signal that is an electrical signal into a plurality of packet signals as optical signals and transmitting the packet signals; and a plurality of optical couplers, each of which multiplexing the plurality of packet signals as optical signals transmitted from some optical transmission devices among the plurality of optical transmission devices and the plurality of packet signals as optical signals transmitted from an optical transmission device different from the some optical transmission devices among the plurality of optical transmission devices, and branching a packet signal as an optical signal obtained by multiplexing into a plurality of transmission signals as optical signals including the same information and outputting the transmission signals. The optical communication system according to the present disclosure further includes: a plurality of optical reception devices, each of which receiving, from the plurality of optical couplers, one of the plurality of transmission signals as optical signals branched by the plurality of optical couplers, and converting the received transmission signal into a second data signal that is an electrical signal and outputting the second data signal; and a control unit that controls operations of the plurality of optical transmission devices and the plurality of optical reception devices. The number of multiplexed signals of some optical couplers among the plurality of optical couplers is smaller than the number of the plurality of optical transmission devices. The number of multiplexed signals of remaining optical couplers among the plurality of optical couplers is the same as the number of the plurality of optical transmission devices. Each of the plurality of optical transmission devices allocates a communication resource to a signal to be transmitted so as to prevent the signal to be transmitted from colliding with a packet signal as an optical signal to be transmitted from another optical transmission device on the basis of a first control signal acquired from the control unit, and transmits the plurality of packet signals as optical signals. Each of the plurality of optical reception devices converts the received transmission signal into a transmission signal as an electrical signal, selects a designated signal portion from the transmission signal as an electrical signal on the basis of a second control signal acquired from the control unit, and outputs the selected signal portion as the second data signal.

### BRIEF DESCRIPTION OF THE DRAWINGS

FIG. 1 is a diagram illustrating a configuration of an optical communication system according to a first embodiment;

FIG. 2 is a diagram illustrating examples of input and output signals of components included in the optical communication system according to the first embodiment;

FIG. 3 is a schematic diagram illustrating a situation in a case where there is a large amount of data aggregated in optical couplers connected to a time division multiple access (TDMA) signal generation unit included in the 25 optical communication system according to the first embodiment, and all transfer request signals cannot enter a time domain;

FIG. 4 is a schematic diagram illustrating examples of input and output signals of the components included in the optical communication system according to the first embodiment in a case where there arises a state in which data retransmission is performed or an increase in delay of transfer data in the first embodiment;

FIG. 5 is a flowchart illustrating a procedure of an operation performed by the optical communication system according to the first embodiment;

FIG. 6 is a flowchart illustrating a procedure of an operation performed by the optical communication system according to a second embodiment;

FIG. 7 is a flowchart illustrating a procedure of an operation performed by the optical communication system according to a third embodiment;

FIG. 8 is a diagram illustrating a processing circuitry in a case where a control unit included in the optical communication system according to the first embodiment is realized by the processing circuitry;

FIG. 9 is a diagram illustrating a processor in a case where the control unit included in the optical communication system according to the first embodiment is realized by the processor; and

FIG. 10 is a diagram illustrating a computer-readable recording medium having recorded therein a program for causing a computer to execute a method to be executed by the optical communication system according to the first embodiment.

### DETAILED DESCRIPTION OF THE PREFERRED EMBODIMENTS

Hereinafter, an optical communication system, a control circuit, a recording medium, and an optical communication method according to each embodiment will be described in detail with reference to the drawings.

### First Embodiment

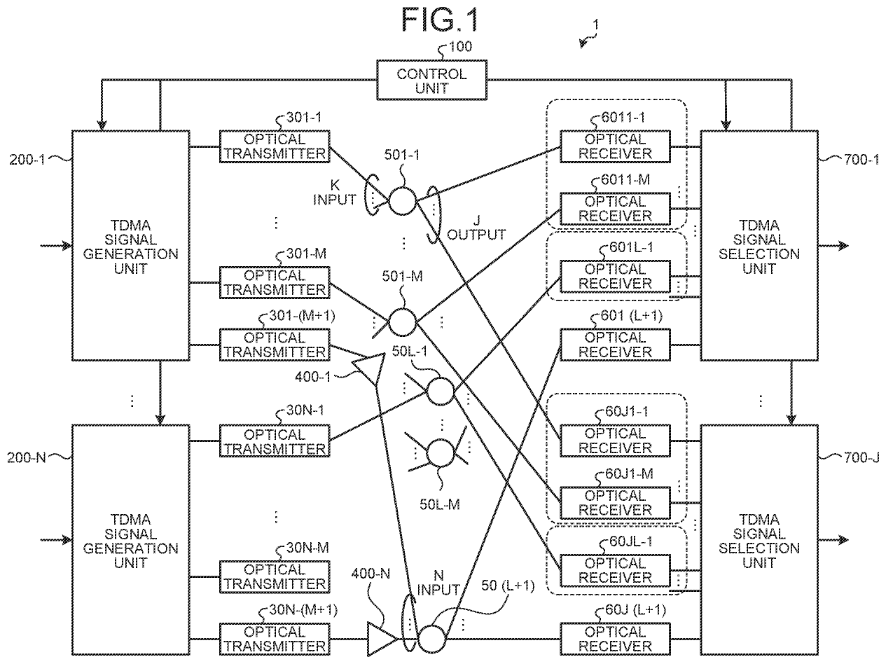

FIG. 1 is a diagram illustrating a configuration of an optical communication system 1 according to a first embodiment. The optical communication system 1 has an N input by J output configuration, and has a function that can switch a signal from any input port to any output port. The optical communication system 1 includes a control unit 100, TDMA signal generation units 200-1 to 200-N, optical transmitters 301-1 to 30N-(M+1), optical amplifiers 400-1 to 400-N, optical couplers 501-1 to 50 (L+1), optical receivers 6011-1 to 60J (L+1), and TDMA signal selection units 700-1 to 700-J. N, M, L, K, and J are all integers of 2 or more. Both L and K are smaller than N. Note that, hereinafter, components included in the optical communication system 1 may not be given reference signs.

The optical transmitters 301-1 to 30N-(M+1) are examples of a plurality of optical transmission devices. Each of a plurality of optical transmitters converts a first data signal which is an electrical signal into a plurality of packet signals as optical signals and transmits the packet signals. The optical couplers 501-1 to 50 (L+1) are examples of a plurality of optical couplers. Each of the plurality of optical couplers multiplexes the plurality of packet signals as optical signals transmitted from some optical transmitters among the plurality of optical transmitters and the plurality of packet signals as optical signals transmitted from an optical transmitter different from the some optical transmitters among the plurality of optical transmitters, and branches a packet signal as an optical signal obtained by multiplexing into a plurality of transmission signals as optical signals including the same information and outputs the transmission signals.

The optical receivers 6011-1 to 60J (L+1) are examples of a plurality of optical reception devices. Each of a plurality of optical receivers receives, from the plurality of optical couplers, one of the plurality of transmission signals as optical signals branched by the plurality of optical couplers, and converts the received transmission signal into a second data signal which is an electrical signal and outputs the second data signal. The control unit 100 controls operations of the plurality of optical transmitters and the plurality of optical receivers. The number of multiplexed signals of some optical couplers among the plurality of optical couplers is smaller than the number of the plurality of optical transmitters. The number of multiplexed signals of remaining optical couplers among the plurality of optical couplers is the same as the number of the plurality of optical transmitters.

Each of the plurality of optical transmitters allocates a communication resource to a signal to be transmitted so as to prevent the signal to be transmitted from colliding with a packet signal as an optical signal to be transmitted from another optical transmitter on the basis of a first control signal acquired from the control unit 100, and transmits the plurality of packet signals as optical signals. Each of the plurality of optical receivers converts the received transmission signal into a transmission signal as an electrical signal, selects a designated signal portion from the transmission signal as an electrical signal on the basis of a second control signal acquired from the control unit 100, and outputs the selected signal portion as the second data signal.

Any of the optical amplifiers 400-1 to 400-N is an optical amplifier located at an output portion of, among the plurality of optical transmitters, an optical transmitter connected to, among the plurality of optical couplers, an optical coupler of which the number of multiplexed signals is the same as the number of the plurality of optical transmitters. Note that the optical communication system 1 may include an optical amplifier located at an input portion of, among the plurality of optical transmitters, an optical transmitter connected to, among the plurality of optical couplers, an optical coupler of which the number of multiplexed signals is the same as the number of the plurality of optical transmitters. The optical communication system 1 may include an optical amplifier located at an input portion and an output portion of, among the plurality of optical transmitters and the plurality of optical receivers, an optical transmitter and an optical receiver connected to, among the plurality of optical couplers, an optical coupler of which the number of multiplexed signals is the same as the number of the plurality of optical transmitters.

Transmission rates of, among the plurality of optical transmitters and the plurality of optical receivers, an optical transmitter and an optical receiver connected to, among the plurality of optical couplers, an optical coupler of which the number of multiplexed signals is the same as the number of the plurality of optical transmitters are lower than transmission rates of an optical transmitter and an optical receiver connected to, among the plurality of optical couplers, an optical coupler of which the number of multiplexed signals is smaller than the number of the plurality of optical transmitters.

The control unit 100 has a function of analyzing the amount of total optical signals that can be multiplexed by, among the plurality of optical couplers, an optical coupler of which the number of multiplexed signals is smaller than the number of the plurality of optical transmitters, and outputting, to each of the plurality of optical transmitters, the first control signal to the effect that in a case where the total optical signals can be multiplexed by the optical coupler, the total optical signals are caused to be transmitted to the optical coupler, and in a case where the total optical signals cannot be multiplexed by the optical coupler, the total optical signals are caused to be transmitted to, among the plurality of optical couplers, an optical coupler of which the number of multiplexed signals is the same as the number of the plurality of optical transmitters.

Each of the plurality of optical transmitters and the plurality of optical receivers stops operation in a time slot in which a packet signal is neither transmitted nor received.

Hereinafter, the components included in the optical communication system 1 will be further described.

The TDMA signal generation units each include groups of optical transceivers having different numbers of input connections at optical couplers connected thereto. For example, focusing on the TDMA signal generation unit 200-1, the optical transmitters 301-1 to 301-M connected to the optical couplers 501-1 to 501-M in each of which the number of optical coupler inputs is K correspond to a first optical transmitter group. The optical transmitter 301-(M+1) connected to the optical coupler 50 (L+1) in which the number of optical coupler inputs is N corresponds to a second optical transmitter group.

Although only one optical transmitter of the optical transmitter 301-(M+1) is illustrated for the second optical transmitter group, optical transmitters the number of which is any integer of 2 or more may be disposed in parallel as in the first optical transmitter group. In a case where the second optical transmitter group includes a plurality of optical transmitters disposed in parallel, a plurality of optical amplifiers from the optical amplifier 400-1 to the optical amplifier 400-N and the optical coupler 50 (L+1) are also parallelized, and a plurality of optical receivers from the optical receiver 601 (L+1) to the optical receiver 60J (L+1) are also parallelized.

Note that, in the first embodiment, the optical amplifiers 400-1, 400-2, . . . , and 400-N are disposed immediately after the optical transmitters, but may be disposed on an output side of the optical coupler 50 (L+1), that is, on a side of the optical receivers 601 (L+1), 602 (L+1), . . . , and 60J (L+1). The optical amplifiers 400-1, 400-2, . . . , and 400-N may be disposed not only on one side, i.e., the input side or the output side of the optical couplers, but also on both sides, i.e., the input side and the output side thereof.

Each of the TDMA signal generation units 200-1 to 200-N converts an input signal into an intermittent signal on the time axis while adjusting timing so as to prevent the input signal from colliding with a time-division multiplexed signal generated by another TDMA signal generation unit on the time axis, and passes the signal to each optical transmitter connected thereto. For example, the TDMA signal generation unit 200-1 passes the signal to the optical transmitters 301-1 to 301-(M+1). The electrical signal output from each of the TDMA signal generation units 200-1 to 200-N may be, except for an intermittent signal portion, a signal including consecutive “O's” indicating no signal, or an idle signal indicating no signal, for example, a signal including alternating “1's” and “0's”.

Since the TDMA signal generation units and the optical transmitters are usually coupled by alternating current (AC) coupling using capacitors, it is common to insert a DC-balanced idle signal in order to avoid direct current (DC) drift. In this case, a gate signal indicating which portion is an intermittent signal portion and which portion is an idle signal other than that is also passed to the optical transmitters through another signal line. The gate signal may be passed from the TDMA signal generation units to the optical transmitters, or may be passed from the control unit 100 that controls the whole to the optical transmitters.

The optical transmitters each convert an electrical signal input from the corresponding TDMA signal generation unit into an optical signal, and send the optical signal to an optical fiber network. For example, each of the optical transmitters 301-1 to 301-(M+1) converts an electrical signal input from the TDMA signal generation unit 200-1 into an optical signal, and sends the optical signal to the optical fiber network. The optical transmitters each emit light only in a time domain in which the signal received from the corresponding TDMA signal generation unit is converted into an optical signal, and transition to a non-light emitting state in other time domains so as not to interfere with signals from other optical transmitters.

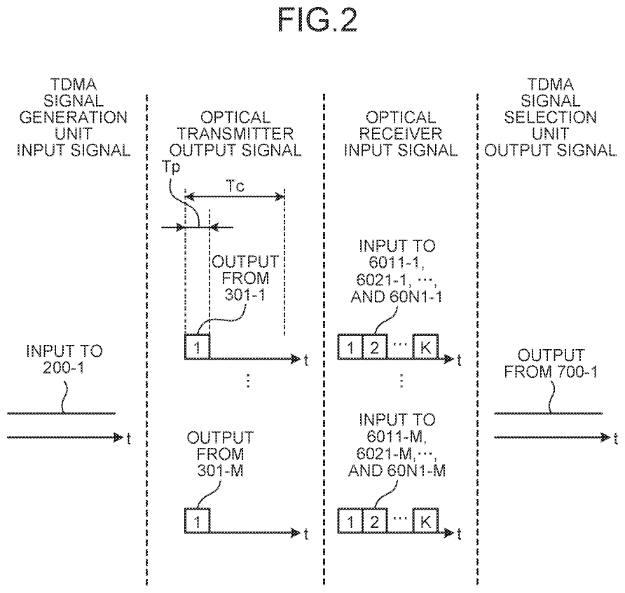

FIG. 2 is a diagram illustrating examples of input and output signals of the components included in the optical communication system 1 according to the first embodiment. As a premise of the input and output signals, a situation is considered in which, in a case where a signal is passed from the TDMA signal generation unit 200-1 to the TDMA signal selection unit 700-1, while a signal to be transferred is generated in all the TDMA signal generation units 200-1 to 200-K, a signal is not transferred to the optical transmitter 301-(M+1).

An input signal to the TDMA signal generation unit is a continuous signal having a constant voltage amplitude. The TDMA signal generation unit cuts off an input signal in a certain time domain or a certain signal block domain, packetizes the input signal in order to pass the signal to each optical transmitter, and correspondingly increases a transmission rate. FIG. 2 illustrates, with emphasis on clarity, a case where the input signal is divided in a time domain. The TDMA signal generation unit divides a signal input thereto in a time domain Tc. All input signals divided in the time domain Tc are passed to the TDMA signal selection unit 700-1.

Thereafter, each TDMA signal generation unit divides the signal into M pieces so that the transmission rate of an output from each optical transmitter does not excessively increase. For example, when Tc=1 msec and M=8, each TDMA signal generation unit divides the signal every ⅛ msec, i.e., 0.125 msec. Each TDMA signal generation unit increases the speed of a signal obtained by the division so as to prevent the signal from colliding with a signal from another TDMA signal generation unit in the time domain Tc. Each TDMA signal generation unit compresses the input signal when considered in terms of the time domain.

For example, in a case where the number K of parallel TDMA signal generation units connected to the same fiber line is two and the optical communication system 1 performs a non-blocking process, a signal time width Tp per optical transceiver is ½ msec, i.e., 0.5 msec. Note that, even if the number of input ports for multiplexing on the same fiber line is larger than two, in a case where the number of ports to be simultaneously switched is small, collision of signals can be avoided even when the above signal time width is longer than 0.5 msec. In addition, although time widths of signals passed to the optical receivers connected to one TDMA signal generation unit are all the same and occur at the same timing in FIG. 2, the time widths of the signals passed to the optical receivers may be different or may not occur at the same timing as long as the signals do not collide with a signal from another TDMA signal generation unit on the optical fiber network.

In FIG. 2, the output signals of the optical transmitters are all denoted as “1”, which is for indicating outputs from the TDMA signal generation unit 200-1, and the contents of packets illustrated in parallel are all different. For example, an output packet from the optical transmitter 301-1 indicates a signal in a relative time from 0 msec to 0.125 msec of an input signal of the TDMA signal generation unit 200-1, and an output packet from the optical transmitter 301-2 indicates a signal in the relative time from 0.125 msec to 0.25 msec.

In the above example, the outputs from the optical transmitters 301-1 to 301-M are input to the optical couplers 501-1 to 501-M and multiplexed. Here, it is assumed that each of the optical couplers has K input ports and J output ports. K is an integer of 2 or more and less than N. Since K is an integer of 2 or more and less than N, the number of input ports of the optical coupler can be reduced, and thus a time width that can be allocated to one optical transmitter can be widened. The time width is Tp in FIG. 2.

A second column from the right in FIG. 2 illustrates packet sequences of the optical receivers 6011-1 to 601L-M connected to the TDMA signal selection unit 700-1 after being multiplexed by the optical couplers. Note that, although the optical receiver 601L-M is not illustrated for simplicity of the figure, the optical receiver 601L-M is prepared inside a rectangular region indicated by a broken line and surrounding the optical receiver 601L-1 in FIG. 1. Note that, since each of the optical couplers 501-1 to 50L-M demultiplexes a signal input thereto and passes the signal also to other optical receivers, the packet sequences of the optical receivers 6011-1 to 601L-M are also received by the optical receivers 6021-1 to 602L-M to the optical receivers 60J1-1 to 60JL-M connected to the TDMA signal selection units 700-2 to 700-J.

According to the above example, regarding the packet sequence illustrated in the uppermost row, a packet described as “1” includes the signal in a relative time from 0 msec to 0.125 msec of the input signal of the TDMA signal generation unit 200-1, a packet described as “2” includes a signal in a relative time from 0 msec to 0.125 msec of an input signal of the TDMA signal generation unit 200-2, and a packet described as “K” includes a signal in a relative time from 0 msec to 0.125 msec of an input signal of the TDMA signal generation unit 200-K, which results in a period of 1 msec in total.

Although not illustrated in FIG. 2, a packet sequence to come next and to be input to the optical receivers 6011-2, 6021-2, . . . , and 60N1-2 contains signals in the relative time from 0.125 msec to 0.25 msec. Since the optical communication system 1 generates the packet sequences as described above, it is possible to reconfigure a signal input from any TDMA signal generation unit into a signal in a relative time from 0 msec to 1 msec and to select a TDMA signal for all the TDMA signal selection units. Note that, up to this point, it is assumed that all the packets are packets having signals of the same relative time width. However, the packets may be packets having signals of time widths different for each TDMA signal generation unit.

Each of the optical receivers 6011-1 to 601L-M converts an input optical signal into an electrical signal. Here, regarding a packet sequence input to a certain optical receiver, a difference in path loss from respective optical transmitters to the optical receiver or output optical power of the optical transmitters results in a difference in optical level among the packets. This difference in optical level may be removable without changing the photoelectric conversion gain of the optical receiver, that is, the signals may be convertible into signals with a constant voltage amplitude, but the photoelectric conversion gain may need to be changed for each packet depending on the configuration.

In addition, since it is difficult to completely align the phases of the signals for each packet at reception ends between different optical transmitters, relative phases are generally different. For example, in a case where a non-return to zero (NRZ) signal is used, a rising phase and a falling edge phase are generally different from each other. In that case, it is necessary to optimize the state of the optical receiver for each packet in order to remove the optical level difference or the phase difference so as to prevent signal loss from occurring. Therefore, a preamble pattern is inserted at the head of each packet. For example, in International Telecommunication Union Telecommunication Standardization Sector (ITU-T) G. 9807.1 that defines 10-Gigabit-capable symmetric passive optical network (XGS-PON) which is a 10 Gbps-class system, a length of from 128.6 ns to 610.9 ns is defined as a preamble length, and it is only required to insert an appropriate preamble pattern depending on the system configuration. The longer the preamble length, the more relaxed optimization time required for the optical transmitters and the optical receivers, but improvement in a transmission rate or a time compression ratio is required in order to maintain desired switching capability.

Regarding electrical signals photoelectrically converted by the optical receivers, only a signal to a necessary destination is extracted in accordance with a control signal input in advance from the control unit 100 to the TDMA signal selection units, and other signals are discarded. Thereafter, the TDMA signal selection units each convert a temporally intermittent extracted signal into a temporally continuous signal, convert the transmission rate in conformity with a system connected at a subsequent stage, and send the signal.

Control information necessary for performing such control and a reference clock for the entire optical communication system 1 to operate in synchronization are supplied from the control unit 100 to the TDMA signal generation units and the TDMA signal selection units. Although not illustrated in FIG. 2, the control unit 100 may supply other necessary control signals to each optical transmitter and each optical receiver. The above other necessary control signals are, for example, state transition signals of the optical transmitters. In addition, although FIG. 2 only illustrates a line through which the control unit 100 supplies signals to other components, each of the components may transmit state information, for example, failure information to the control unit 100 as necessary, and the control unit 100 may change the allocation or destinations of the packet signals on the basis of the state information.

The above method is a signal transfer method when the optical transmitter 301-(M+1) is not used in a case where a signal is transferred from the TDMA signal generation unit 200-1 to the TDMA signal selection unit 700-1. Hereinafter, a signal transfer method in a case where the optical transmitter 301-(M+1) is also used will be described. Note that, even in the case where the optical transmitter 301-(M+1) is used, the contents of the above description are maintained unless otherwise specified.

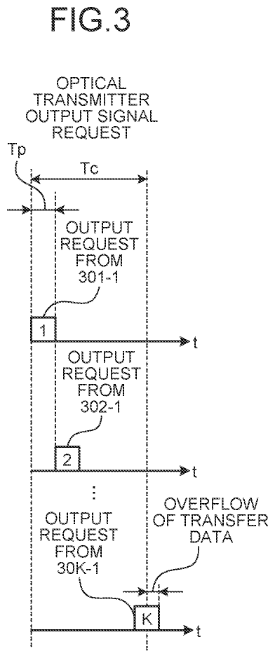

FIG. 3 is a schematic diagram illustrating a situation in a case where there is a large amount of data aggregated in the optical couplers 501-1 to 501-M connected to the TDMA signal generation unit 200-1 included in the optical communication system 1 according to the first embodiment, and all transfer request signals cannot enter the time domain Tc. In this case, since the data of all the TDMA signal generation units 200-1 to 200-K cannot enter the time domain Tc, it is necessary to discard overflowing data or to buffer the overflowing data in the TDMA signal generation units until a time domain next to the illustrated time domain Tc. In a case of discarding the data, it is necessary to retransmit the data between the TDMA signal generation units and the TDMA signal selection units, and in a case of buffering the data, delay of transfer data increases.

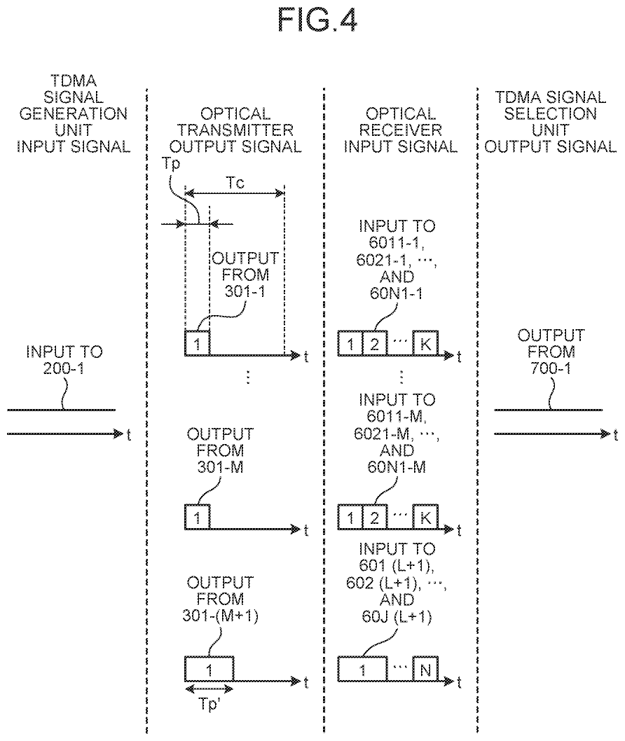

In a case where the above state occurs, it is assumed that the amount of data aggregated in optical coupler groups other than the optical coupler group in which this state occurs is relatively small. Examples of the optical coupler group in which this state occurs include the optical couplers 501-1 to 501-M, and examples of the optical coupler groups other than the optical coupler group in which this state occurs include the optical couplers 502-1 to 502-M, 503-1 to 503-M, . . . , and 50L-1 to 50L-M. FIG. 4 is a schematic diagram illustrating examples of input and output signals of the components included in the optical communication system 1 according to the first embodiment in a case where there arises a state in which data retransmission is performed or an increase in delay of transfer data in the first embodiment.

In this case, each of the TDMA signal generation units connected to the optical couplers 502-1 to 502-M, 503-1 to 503-M, . . . , and 50L-1 to 50L-M can transfer a signal to a desired TDMA signal selection unit without transferring data to the (M+1)th optical transmitter. Meanwhile, the TDMA signal generation unit 200-1 divides the signal in consideration also of the optical transmitter 301-(M+1) in order to avoid overflow of the transfer data. Consequently, regarding signals to be input to the optical receivers 601 (L+1), 602 (L+1), . . . , and 60J (L+1), only a signal from the optical transmitter 301-(M+1) or only signals from limited optical transmitters are multiplexed on the time axis on the optical fiber transmission line. Therefore, it is more likely that a time width Tp′ that can be allocated to the optical transmitter 301-(M+1) can be increased as compared with the time width Tp.

In general, in a switch having a plurality of input ports and a plurality of output ports, an increase in the number of ports results in more time slots in which data is input and output to and from any port but data is not input and output to and from other ports, than time slots in which data is uniformly input to all ports. Therefore, there is an advantage that a long time domain of data is more easily taken due to a statistical multiplexing effect when aggregating data from all input ports than when aggregating data only from limited input ports as illustrated in FIG. 1. The time domain is Tp′ in FIG. 4.

However, in a case where all the input ports and all the output ports are connected by the optical couplers, branch loss is determined by the number N of input ports or the number J of output ports, whichever is larger. Therefore, as illustrated in FIG. 1, the optical communication system 1 includes the optical amplifiers 400-1 to 400-N, thereby compensating for loss generated in the optical coupler 50 (L+1) and ensuring optical reception power enough to reproduce signals in the optical receivers.

Note that, in a case where one or both of output optical power of the optical transmitters and light-receiving sensitivity of the optical receivers are high, the optical receivers can reproduce signals without the optical amplifiers, and therefore, in such a case, the optical amplifiers 400-1 to 400-N may be removed, and the optical transmitters may be directly connected to the optical couplers.

In addition, the transmission rates of the optical transmitters 301-(M+1), 302-(M+1), . . . , and 30N-(M+1) and the optical receivers 601 (L+1), 602 (L+1), . . . , and 60J (L+1) may be lower than those of the other optical transmitters and optical receivers. For example, by setting the transmission rates of the optical transmitters 301-(M+1), 302-(M+1), . . . , and 30N-(M+1) and the optical receivers 601 (L+1), 602 (L+1), . . . , and 60J (L+1) to 1/10 of the transmission rates of the other optical transmitters and optical receivers, reception sensitivity in optical reception can be improved by 10 to 15 dB. In this case, it is possible to increase the number N of input ports and the number J of output ports with which signal transmission can be performed without using the optical amplifiers 400-1, 400-2, . . . , and 400-N.

Also for the optical transmitters and the optical receivers of which the transmission rates are reduced, as described above, the numbers of optical transmitters and optical receivers connected to each TDMA signal generation unit and each TDMA signal selection unit may be each an integer value of 2 or more, and each of the plurality of optical transmitters and the plurality of optical receivers may be disposed in parallel.

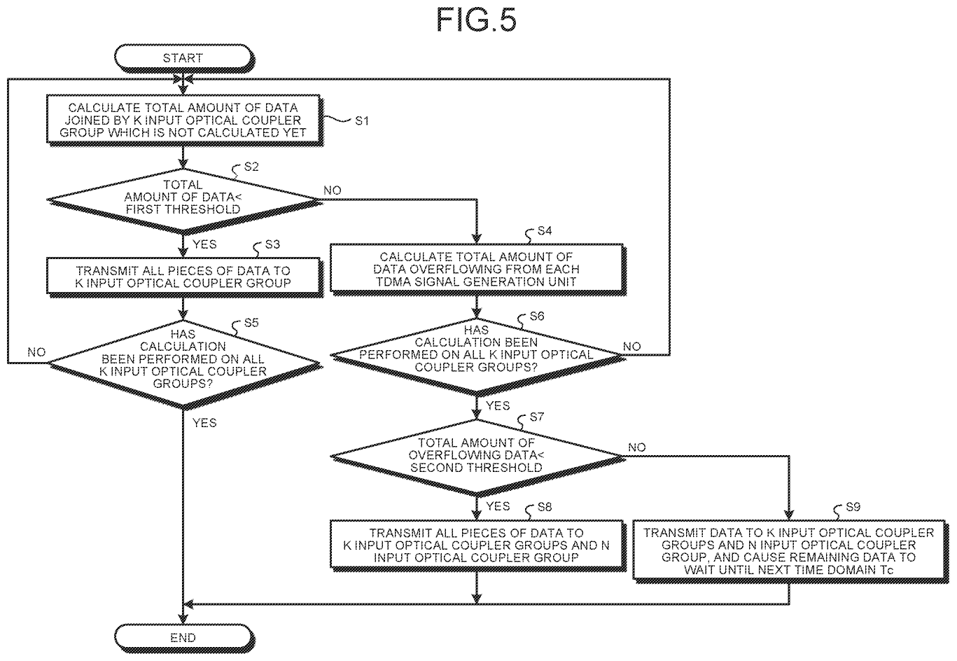

Here, when transfer data is allocated to the optical transmitters 301-(M+1), 302-(M+1), . . . , and 30N-(M+1) in the first embodiment will be described with reference to a flowchart of FIG. 5. FIG. 5 is a flowchart illustrating a procedure of an operation performed by the optical communication system 1 according to the first embodiment. The operation illustrated in this flowchart is performed for each time domain Tc to which data is allocated.

The control unit 100 calculates, for each time domain Tc, how much time width Tp can be allocated after a K input optical coupler group, that is, in terms of the TDMA signal generation unit 200-1, M optical couplers of the optical couplers 501-1, 501-2, . . . , and 501-M join (S1). That is, in step S1, the control unit 100 calculates the total amount of data joined by the K input optical coupler group which is not calculated yet. The calculation in step S1 can be performed because the control unit 100 has known in advance how to perform switching from all the TDMA signal generation units 200-1 to 200-N to all the TDMA signal selection units 700-1 to 700-J. In order for the control unit 100 to know switching information, the switching information may be input to the control unit 100 from the outside of the optical communication system 1, or each TDMA signal generation unit may read destination TDMA signal selection unit information from header information of a signal input thereto, and pass destination information and the amount of transfer data to the control unit 100.

The control unit 100 determines whether the calculated total amount of data after the K input optical coupler group joins is smaller than a preset first threshold at which a TDMA signal can be transferred (S2). Examples of the K input optical coupler group include the optical couplers 501-1, 501-2, . . . , and 501-M. If the control unit 100 determines that the total amount of data is smaller than the first threshold (Yes in S2), the optical transmitters transmit all pieces of data to the K input optical coupler group (S3). The first threshold can be determined as a value obtained by excluding the length of a preamble to be added to the head of each TDMA signal in the time domain Tc, time required for packet intervals, and information related to encoding required for transmission. An example of the information related to encoding required for transmission is a parity bit in a case where a 64B/66B transmission code as defined in 10 Gigabit Ethernet (registered trademark) or a forward error correction code is used.

On the other hand, if the control unit 100 determines that the calculated total amount of data after the K input optical coupler group joins is greater than or equal to the first threshold (No in S2), the control unit 100 calculates and stores the total amount of data to overflow from each TDMA signal generation unit connected to the K input optical coupler group (S4). For example, the K input optical coupler group is optical couplers 501-1, 501-2, . . . , and 501-M, and the TDMA signal generation units are TDMA signal generation units 200-1, 200-2, . . . , and 200-K.

The control unit 100 performs a calculation similar to the above calculation on another K input optical coupler group. Examples of the another K input optical coupler group include the optical couplers 502-1, 502-2, . . . , and 502-M. That is, the control unit 100 performs a calculation similar to the above calculation sequentially to a last K input optical coupler group. The last K input optical coupler group is the optical couplers 50L-1, 50L-2, . . . , and 50L-M.

Specifically, after performing the operations in steps S3 and S4, the control unit 100 determines whether the calculation has been performed on all the K input optical coupler groups (S5 and S6). If the control unit 100 determines that the calculation has not been performed on all the K input optical coupler groups (No in S5 and S6), the control unit 100 executes the operation in step S1. If the control unit 100 determines that the calculation has been performed on all the K input optical coupler groups (Yes in S5), the optical communication system 1 ends a first operation.

That is, regarding all the K input optical coupler groups, in a case where the total amount of data is smaller than the first threshold, the control unit 100 ends the calculation, and the operation of the optical communication system 1 transitions to a mode of waiting for the next time domain Tc. On the other hand, in a case where the total amount of data of at least one of the K input optical coupler groups is greater than or equal to the first threshold, that is, if the control unit 100 determines that the calculation has been performed on all the K input optical coupler groups (Yes in S6), the control unit 100 determines whether the total amount of data overflowing from all the K input optical coupler groups is smaller than a second threshold (S7). The second threshold is a preset threshold at which a TDMA signal can be transferred by an N input optical coupler group.

If the control unit 100 determines that the total amount of overflowing data is smaller than the second threshold (Yes in S7), the optical transmitters transmit all pieces of data to the K input optical coupler groups and the N input optical coupler group (S8). Similarly to the first threshold, the second threshold can be determined as a value obtained by excluding the length of a preamble to be added to the head of each TDMA signal in the time domain Tc, time required for packet intervals, and information related to encoding required for transmission. An example of the information related to encoding is a parity bit in a case where a 64B/66B transmission code as defined in 10 Gigabit Ethernet (registered trademark) or a forward error correction code is used.

On the other hand, if the control unit 100 determines that the total amount of the overflowing data is greater than or equal to the second threshold (No in S7), the optical transmitters each allocate and transmit data having a maximum allocatable amount to the K input optical coupler groups and the N input optical coupler group, and remaining data that cannot be allocated is preferentially allocated as transfer data after waiting until the next time domain Tc (S9).

By performing the operation illustrated in the flowchart of FIG. 5, the optical communication system 1 according to the first embodiment can efficiently perform data transfer as a whole even in a case where pieces of input data are concentrated only on a TDMA signal generation unit connected to a specific K input optical coupler group and less pieces of data are input to other TDMA signal generation units. Furthermore, the optical communication system 1 includes the optical couplers which are passive elements for both of combining and branching of signals, and thus it is possible to perform switching from any input port to any output port, to realize low power consumption and high reliability, and to realize highly efficient transfer.

### Second Embodiment

As described above, in the first embodiment, the method has been described in which the signals input to the TDMA signal generation units are first distributed to the K input optical coupler groups, and the overflowing signals are distributed to the N input optical coupler group. However, the signals may be distributed by a method different from the method of the first embodiment. In a second embodiment, a method for distributing signals depending on the priority of the signals will be described. In the second embodiment, differences from the first embodiment will be mainly described.

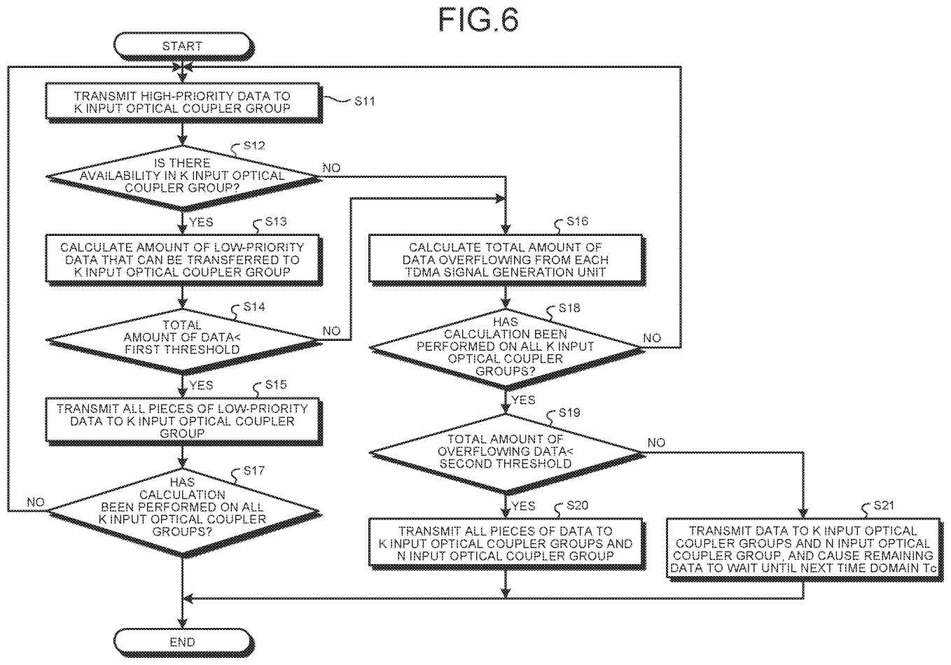

When transfer data is allocated to the optical transmitters 301-(M+1), 302-(M+1), . . . , and 30N-(M+1) in the second embodiment will be described with reference to a flowchart of FIG. 6. FIG. 6 is a flowchart illustrating a procedure of an operation performed by the optical communication system 1 according to the second embodiment. Note that, configurations of the control unit and the TDMA signal generation units to the TDMA signal selection units are the same as the configurations described in the first embodiment.

Similarly to the first embodiment, the control unit 100 calculates, for each time domain Tc, how much time width Tp can be allocated after the K input optical coupler group, that is, in terms of the TDMA signal generation unit 200-1, the M optical couplers of the optical couplers 501-1, 501-2, . . . , and 501-M join. The above calculation performed by the control unit 100 can be performed because the control unit 100 has known in advance how to perform switching from all the TDMA signal generation units 200-1 to 200-N to all the TDMA signal selection units 700-1 to 700-J. In order for the control unit 100 to know switching information, the switching information may be input to the control unit 100 from the outside of the optical communication system 1, or each TDMA signal generation unit may read destination TDMA signal selection unit information from header information of a signal input thereto, and pass destination information and the amount of transfer data to the control unit 100.

In the second embodiment, the control unit 100 uses the priority of the data as a calculation basis of the allocated time width Tp to be calculated. First, the optical transmitters each transmit high-priority data to a certain K input optical coupler group (S11). Examples of the K input optical coupler group include the optical couplers 501-1, 501-2, . . . , and 501-M. Here, it is assumed that the amount of the high-priority data does not exceed the amount of data that can be transferred to the K input optical coupler group. If the amount of the high-priority data exceeds the above amount, the control unit 100 performs adjustment, and cancels high priority or waits until the next time domain Tc.

After the high-priority data is transmitted to the K input optical coupler group, the control unit 100 determines whether there is time available for data allocation in the K input optical coupler group (S12). If the control unit 100 determines that there is time available for the data allocation in the K input optical coupler group (Yes in S12), the control unit 100 calculates the amount of low-priority data that can be transferred to the K input optical coupler group (S13). The low-priority data is data other than the high-priority data. The control unit 100 determines whether the amount of the low-priority data is in no excess of the preset first threshold at which a TDMA signal can be transferred (S14). That is, in step S14, the control unit 100 determines whether the total amount of data regarding the low-priority data is smaller than the first threshold.

If the control unit 100 determines that the total amount of data regarding the low-priority data is smaller than the first threshold (Yes in S14), the optical transmitters transmit all pieces of the low-priority data to the K input optical coupler group (S15). Here, the first threshold can be determined as a value obtained by excluding the length of a preamble to be added to the head of each TDMA signal in the time domain Tc, time required for packet intervals, and information related to encoding required for transmission. An example of the information related to encoding required for transmission is a parity bit in a case where a 64B/66B transmission code as defined in 10 Gigabit Ethernet (registered trademark) or a forward error correction code is used.

If the control unit 100 determines that there is no time available in the K input optical coupler group after the allocation of the high-priority data only (No in S12), and if the control unit 100 determines that the total amount of data regarding the low-priority data is greater than or equal to the first threshold (No in S14), the control unit 100 calculates and stores the total amount of data which is the amount of data to overflow from each TDMA signal generation unit connected to the K input optical coupler group (S16). Examples of each TDMA signal generation unit connected to the K input optical coupler group described above include the TDMA signal generation units 200-1, 200-2, . . . , and 200-K.

The control unit 100 performs a calculation similar to the above calculation on another K input optical coupler group. Examples of the another K input optical coupler group include the optical couplers 502-1, 502-2, . . . , and 502-M. That is, the control unit 100 performs a calculation similar to the above calculation sequentially to a last K input optical coupler group. The last K input optical coupler group is the optical couplers 50L-1, 50L-2, . . . , and 50L-M.

Specifically, after performing the operation in step S15, the control unit 100 determines whether the calculation has been performed on all the K input optical coupler groups (S17). If the control unit 100 determines that the calculation has not been performed on all the K input optical coupler groups (No in S17), the control unit 100 executes the operation in step S11. If the control unit 100 determines that the calculation has been performed on all the K input optical coupler groups (Yes in S17), the optical communication system 1 according to the second embodiment ends the operation. That is, if all pieces of data are transmitted to all the K input optical coupler groups, then the calculation is ended, and the operation of the optical communication system 1 transitions to a mode of waiting for the next time domain Tc.

After performing the operation in step S16, the control unit 100 performs the same operation as the operation in step S17 (S18). If the control unit 100 determines that the calculation has not been performed on all the K input optical coupler groups (No in S18), the control unit 100 executes the operation in step S11. If the control unit 100 determines that the calculation has been performed on all the K input optical coupler groups (Yes in S18), the control unit 100 determines whether the total amount of data overflowing from all the K input optical coupler groups is in no excess of the preset second threshold at which a TDMA signal can be transferred by the N input optical coupler group (S19).

If the control unit 100 determines that the total amount of data overflowing from all the K input optical coupler groups is in no excess of the second threshold (Yes in S19), the optical transmitters transmit all pieces of data to the K input optical coupler groups and the N input optical coupler group (S20). Similarly to the first threshold, the second threshold can be determined as a value obtained by excluding the length of a preamble to be added to the head of each TDMA signal in the time domain Tc, time required for packet intervals, and information related to encoding required for transmission. An example of the information related to encoding is a parity bit in a case where a 64B/66B transmission code as defined in 10 Gigabit Ethernet (registered trademark) or a forward error correction code is used.

On the other hand, if the control unit 100 determines that the total amount of the overflowing data is greater than or equal to the second threshold (No in S19), the optical transmitters each allocate and transmit data having a maximum allocatable amount to the K input optical coupler groups and the N input optical coupler group, and remaining data that cannot be allocated is allocated as transfer data preferentially among pieces of the low-priority data after waiting until the next time domain Tc (S21).

In the second embodiment, the priority has been classified into two types, i.e., the high priority and the low priority, and described. However, the priority may be classified into three or more types, and in that case, data is allocated to the K input optical coupler group in order from the highest priority.

In addition, also for data allocation to the N-input optical coupler group, data is allocated in order from highest-priority data among the pieces of data overflowing from all the TDMA signal generation units, and in a case where there is lower-priority data as remaining data, time is allocated thereto as transfer data preferentially among pieces of data with the same priority after waiting until the next time domain Tc.

According to the second embodiment, it is possible, while reliably transferring high-priority data first, to efficiently perform data transfer as a whole even in a case where pieces of input data are concentrated only on a TDMA signal generation unit connected to a specific K input optical coupler group and less pieces of data are input to other TDMA signal generation units.

Hereinafter, the control unit 100 of the second embodiment will be further described. The control unit 100 analyzes the priority of the first data signal to be converted into optical signals by each of the plurality of optical transmitters, and causes a data signal with the highest priority in the first data signal to be transmitted to, among the plurality of optical couplers, an optical coupler of which the number of multiplexed signals is smaller than the number of the plurality of optical transmitters. The control unit 100 outputs, to each of the plurality of optical transmitters, the first control signal to the effect that in a case where a data signal with the second highest priority in the first data signal can be multiplexed by, among the plurality of optical couplers, an optical coupler of which the number of multiplexed signals is smaller than the number of the plurality of optical transmitters, the data signal with the second highest priority is caused to be transmitted to the optical coupler, and in a case where the data signal with the second highest priority cannot be multiplexed by the optical coupler, the data signal with the second highest priority is caused to be transmitted to, among the plurality of optical couplers, an optical coupler of which the number of multiplexed signals is the same as the number of the plurality of optical transmitters.

### Third Embodiment

As described above, in the first and second embodiments, the method has been described in which the signals input to the TDMA signal generation units are first distributed to the K input optical coupler groups, and the overflowing signals are distributed to the N input optical coupler group. However, the signals may be distributed by a different method. In a third embodiment, a method will be described in which a data allocation method is changed depending on nonuniformity of the density of data of the optical communication system 1 as a whole. In the third embodiment, differences from the first embodiment will be mainly described.

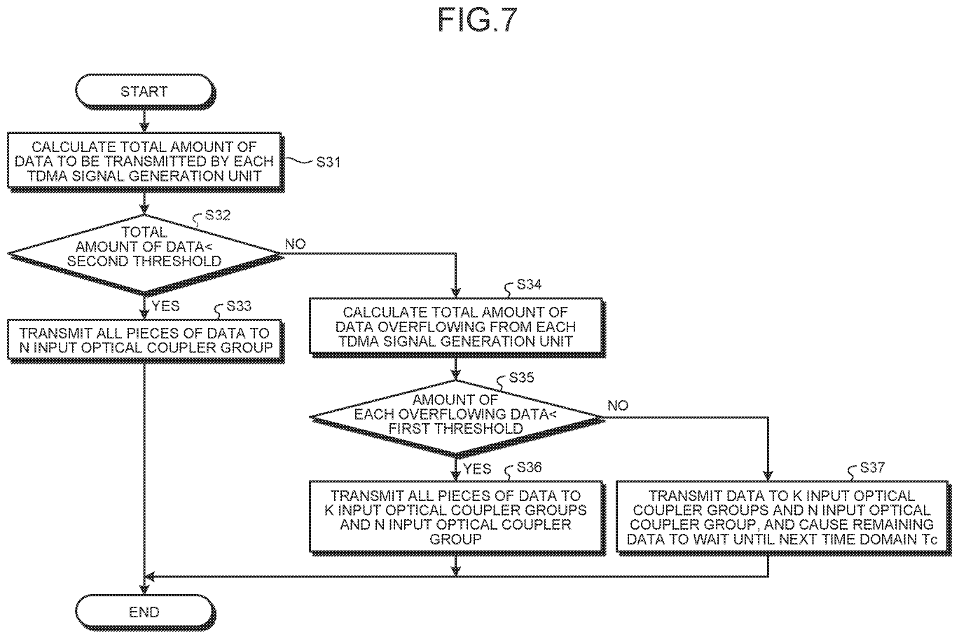

When transfer data is allocated to the optical transmitters 301-(M+1), 302-(M+1), and 30N-(M+1) in the third embodiment will be described with reference to a flowchart of FIG. 7. FIG. 7 is a flowchart illustrating a procedure of an operation performed by the optical communication system 1 according to the third embodiment. Note that, configurations of the control unit and the TDMA signal generation units to the TDMA signal selection units are the same as the configurations described in the first embodiment.

Similarly to the first embodiment, the control unit 100 calculates, for each time domain Tc, how much time width Tp can be allocated after the K input optical coupler group, that is, in terms of the TDMA signal generation unit 200-1, the M optical couplers of the optical couplers 501-1, 501-2, . . . , and 501-M join. The above calculation performed by the control unit 100 can be performed because the control unit 100 has known in advance how to perform switching from all the TDMA signal generation units 200-1 to 200-N to all the TDMA signal selection units 700-1 to 700-J. In order for the control unit 100 to know switching information, the switching information may be input to the control unit 100 from the outside of the optical communication system 1, or each TDMA signal generation unit may read destination TDMA signal selection unit information from header information of a signal input thereto, and pass destination information and the amount of transfer data to the control unit 100.

In the third embodiment, the control unit 100 uses, as a calculation basis of allocated time width Tp to be calculated, the amount of data to be transmitted from all the TDMA signal generation units connected to a switch. First, the control unit 100 calculates the total amount of data which is the total amount of data necessary to be transmitted by each TDMA signal generation unit (S31).

Next, the control unit 100 determines whether the total amount of data is smaller than the preset second threshold at which a TDMA signal can be transferred by the N input optical coupler group (S32). If the control unit 100 determines that the total amount of data is smaller than the second threshold (Yes in S32), the optical transmitters transmit all pieces of data to the N input optical coupler group (S33). The second threshold can be determined as a value obtained by excluding the length of a preamble to be added to the head of each TDMA signal in the time domain Tc, time required for packet intervals, and information related to encoding required for transmission. An example of the information related to encoding is a parity bit in a case where a 64B/66B transmission code as defined in 10 Gigabit Ethernet (registered trademark) or a forward error correction code is used.

If the control unit 100 determines that the total amount of data is greater than or equal to the second threshold (No in S32), the control unit 100 calculates and stores the total amount of data to overflow from each TDMA signal generation unit connected to the N input optical coupler group (S34). Next, for each K input optical coupler group, the control unit 100 determines whether the amount of overflowing data is smaller than the first threshold at which a TDMA signal can be transferred by each K input optical coupler group (S35). If the control unit 100 determines that the amount of overflowing data is smaller than the first threshold (Yes in S35), the optical transmitters transmit all pieces of data to the K input optical coupler groups and the N input optical coupler group (S36).

Similarly to the second threshold, the first threshold can be determined as a value obtained by excluding the length of a preamble to be added to the head of each TDMA signal in the time domain Tc, time required for packet intervals, and information related to encoding required for transmission. An example of the information related to encoding is a parity bit in a case where a 64B/66B transmission code as defined in 10 Gigabit Ethernet (registered trademark) or a forward error correction code is used.

If all pieces of data are transmitted to the N input optical coupler group and all the K input optical coupler groups, then the calculation is ended, and the operation of the optical communication system 1 transitions to a mode of waiting for the next time domain Tc. On the other hand, if the control unit 100 determines that the total amount of data of at least one of the K input optical coupler groups is greater than or equal to the first threshold (No in S35), the optical transmitters each allocate and transmit data having a maximum allocatable amount to the K input optical coupler groups and the N input optical coupler group, and remaining data that cannot be allocated is preferentially allocated as transfer data after waiting until the next time domain Tc (S37).

According to the third embodiment, it is possible to reduce the probability of data transfer particularly to the K input optical coupler groups, which leads to a larger number of receivers. As a result, it is possible to power off all or some of the optical transmitters and the optical receivers connected to the K input optical coupler groups not responsible for data transfer in the time domain Tc, the components of the TDMA signal generation units involved in transmission, and the components of the TDMA signal selection units involved in reception, and thus it is possible to realize low power consumption of the optical communication system 1 as a whole.

Hereinafter, the control unit 100 of the third embodiment will be further described. The control unit 100 analyzes the total amount of data of the first data signal input to the plurality of optical transmitters, and outputs, to each of the plurality of optical transmitters, the first control signal to the effect that in a case where as a result of the analysis, the first data signal can be multiplexed by, among the plurality of optical couplers, an optical coupler of which the number of multiplexed signals is the same as the number of the plurality of optical transmitters, the first data signal is caused to be transmitted to the optical coupler, and in a case where the first data signal cannot be multiplexed by the optical coupler, the first data signal is caused to be transmitted to, among the plurality of optical couplers, an optical coupler of which the number of multiplexed signals is smaller than the number of the plurality of optical transmitters. The first data signal is a data signal to be converted into optical signals by each of the plurality of optical transmitters.

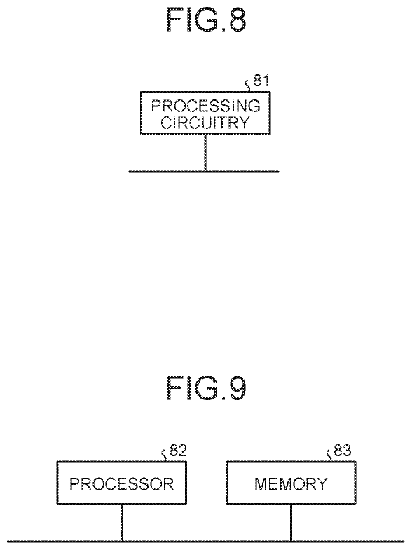

FIG. 8 is a diagram illustrating a processing circuitry 81 in a case where the control unit 100 included in the optical communication system 1 according to the first embodiment is realized by the processing circuitry 81. That is, the control unit 100 may be realized by the processing circuitry 81. Furthermore, the control unit 100 may be a control circuit. The processing circuitry 81 is dedicated hardware. The processing circuitry 81 is, for example, a single circuit, a composite circuit, a programmed processor, a parallel programmed processor, an ASIC, an FPGA, or a combination thereof.

FIG. 9 is a diagram illustrating a processor 82 in a case where the control unit 100 included in the optical communication system 1 according to the first embodiment is realized by the processor 82. That is, a function of the control unit 100 may be realized by the processor 82 executing a program stored in a memory 83. The processor 82 is a central processing unit (CPU), a processing system, an arithmetic system, a microprocessor, or a digital signal processor (DSP). FIG. 9 also illustrates the memory 83.

In a case where a function of the control unit 100 is realized by the processor 82, the function is realized by the processor 82 and software, firmware, or a combination of software and firmware. The software or the firmware is described as a program and stored in the memory 83. The processor 82 reads and executes the program stored in the memory 83, thereby realizing the function of the control unit 100.

In the case where the function of the control unit 100 is realized by the processor 82, the optical communication system 1 includes the memory 83 for storing a program with which a step to be executed by the control unit 100 is executed as a result. It can be said that the program stored in the memory 83 causes a computer to execute a procedure or method to be executed by the control unit 100.

The memory 83 is, for example, a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)); a magnetic disk; a flexible disk; an optical disk; a compact disc; a mini disk; a digital versatile disk (DVD); or the like.

Regarding a plurality of functions of the control unit 100, a part of the plurality of functions may be realized by software or firmware, and the rest of the plurality of functions may be realized by dedicated hardware. Thus, the plurality of functions of the control unit 100 can be realized by hardware, software, firmware, or a combination thereof.

The control units 100 of the second and third embodiments may be each realized by a processing circuitry. The processing circuitry is a processing circuitry similar to the processing circuitry 81. The control units 100 of the second and third embodiments may be each realized by a processor executing a program stored in a memory. The memory is a memory similar to the memory 83. The processor is a processor similar to the processor 82.

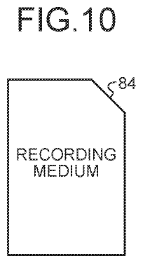

FIG. 10 is a diagram illustrating a computer-readable recording medium 84 having recorded therein a program for causing a computer to execute a method to be executed by the optical communication system 1 according to the first embodiment. That is, the recording medium 84 is a computer-readable recording medium having recorded therein a program for causing a computer to execute a procedure in which each of the plurality of optical transmitters converts the first data signal which is an electrical signal into a plurality of packet signals as optical signals and transmits the packet signals, and a procedure in which each of the plurality of optical couplers multiplexes the plurality of packet signals as optical signals transmitted from some optical transmitters among the plurality of optical transmitters and the plurality of packet signals as optical signals transmitted from an optical transmitter different from the some optical transmitters among the plurality of optical transmitters, and branches a packet signal as an optical signal obtained by multiplexing into a plurality of transmission signals as optical signals including the same information and outputs the transmission signals. The recording medium 84 is a computer-readable recording medium having recorded therein a program for causing a computer to further execute a procedure in which each of the plurality of optical receivers receives, from the plurality of optical couplers, one of the plurality of transmission signals as optical signals branched by the plurality of optical couplers, and converts the received transmission signal into the second data signal which is an electrical signal and outputs the second data signal, and a procedure in which the control unit controls operations of the plurality of optical transmitters and the plurality of optical receivers. The recording medium 84 is a computer-readable recording medium having recorded therein a program for causing a computer to further execute a procedure in which each of the plurality of optical transmitters allocates a communication resource to a signal to be transmitted so as to prevent the signal to be transmitted from colliding with a packet signal as an optical signal to be transmitted from another optical transmitter on the basis of the first control signal acquired from the control unit, and transmits the plurality of packet signals as optical signals, and a procedure in which each of the plurality of optical receivers converts the received transmission signal into a transmission signal as an electrical signal, selects a designated signal portion from the transmission signal as an electrical signal on the basis of the second control signal acquired from the control unit, and outputs the selected signal portion as the second data signal. The number of multiplexed signals of some optical couplers among the plurality of optical couplers is smaller than the number of the plurality of optical transmitters. The number of multiplexed signals of remaining optical couplers among the plurality of optical couplers is the same as the number of the plurality of optical transmitters.

The optical communication system according to the present disclosure achieves an effect that it is possible to perform switching from any input port to any output port, to realize low power consumption and high reliability, and to realize highly efficient transfer.

The configurations described in the above embodiments are merely examples and can be combined with other known technology, the embodiments can be combined with each other, and part of the configurations can be omitted or modified without departing from the gist thereof.

What is claimed is:

1. An optical communication system comprising:
a plurality of optical transmission devices, each of which converting a first data signal that is an electrical signal into a plurality of packet signals as optical signals and transmitting the packet signals;
a plurality of optical couplers, each of which multiplexing the plurality of packet signals as optical signals transmitted from some optical transmission devices among the plurality of optical transmission devices and the plurality of packet signals as optical signals transmitted from an optical transmission device different from the some optical transmission devices among the plurality of optical transmission devices, and branching a packet signal as an optical signal obtained by multiplexing into a plurality of transmission signals as optical signals including same information and outputting the transmission signals;
a plurality of optical reception devices, each of which receiving, from the plurality of optical couplers, one of the plurality of transmission signals as optical signals branched by the plurality of optical couplers, and converting the received transmission signal into a second data signal that is an electrical signal and outputting the second data signal; and
a controlling circuitry to control operations of the plurality of optical transmission devices and the plurality of optical reception devices, wherein
a number of multiplexed signals of some optical couplers among the plurality of optical couplers is smaller than a number of the plurality of optical transmission devices,
a number of multiplexed signals of remaining optical couplers among the plurality of optical couplers is same as the number of the plurality of optical transmission devices,
each of the plurality of optical transmission devices allocates a communication resource to a signal to be transmitted so as to prevent the signal to be transmitted from colliding with a packet signal as an optical signal to be transmitted from another optical transmission device on a basis of a first control signal acquired from the controlling circuitry, and transmits the plurality of packet signals as optical signals, and
each of the plurality of optical reception devices converts the received transmission signal into a transmission signal as an electrical signal, selects a designated signal portion from the transmission signal as an electrical signal on a basis of a second control signal acquired from the controlling circuitry, and outputs the selected signal portion as the second data signal.

2. The optical communication system according to claim 1, further comprising:
an optical amplifier located at an output portion of, among the plurality of optical transmission devices, an optical transmission device connected to, among the plurality of optical couplers, an optical coupler of which a number of multiplexed signals is same as the number of the plurality of optical transmission devices.

3. The optical communication system according to claim 1, further comprising:
an optical amplifier located at an input portion of, among the plurality of optical reception devices, an optical reception device connected to, among the plurality of optical couplers, an optical coupler of which a number of multiplexed signals is same as the number of the plurality of optical transmission devices.

4. The optical communication system according to claim 1, further comprising:
an optical amplifier located at an input portion and an output portion of, among the plurality of optical transmission devices and the plurality of optical reception devices, an optical transmission device and an optical reception device connected to, among the plurality of optical couplers, an optical coupler of which a number of multiplexed signals is same as the number of the plurality of optical transmission devices.

5. The optical communication system according to claim 1, wherein
transmission rates of, among the plurality of optical transmission devices and the plurality of optical reception devices, an optical transmission device and an optical reception device connected to, among the plurality of optical couplers, an optical coupler of which a number of multiplexed signals is same as the number of the plurality of optical transmission devices are lower than transmission rates of an optical transmission device and an optical reception device connected to, among the plurality of optical couplers, an optical coupler of which a number of multiplexed signals is smaller than the number of the plurality of optical transmission devices.

6. The optical communication system according to claim 1, wherein
the controlling circuitry analyzes an amount of total optical signals multiplexable by, among the plurality of optical couplers, an optical coupler of which a number of multiplexed signals is smaller than the number of the plurality of optical transmission devices, and outputs, to each of the plurality of optical transmission devices, the first control signal to an effect that the total optical signals are caused to be transmitted to the optical coupler in a case where the total optical signals are multiplexable by the optical coupler, and the total optical signals are caused to be transmitted to, among the plurality of optical couplers, an optical coupler of which a number of multiplexed signals is same as the number of the plurality of optical transmission devices in a case where the total optical signals are not multiplexable by the optical coupler.

7. The optical communication system according to claim 1, wherein
the controlling circuitry analyzes priority of the first data signal, causes a data signal with highest priority in the first data signal to be transmitted to, among the plurality of optical couplers, an optical coupler of which a number of multiplexed signals is smaller than the number of the plurality of optical transmission devices, and outputs, to each of the plurality of transmission devices, the first control signal to an effect that in a case where a data signal with second highest priority in the first data signal is multiplexable by, among the plurality of optical couplers, an optical coupler of which a number of multiplexed signals is smaller than the number of the plurality of optical transmission devices, the data signal with second highest priority is caused to be transmitted to the optical coupler, and in a case where the data signal with second highest priority is not multiplexable by the optical coupler, the data signal with second highest priority is caused to be transmitted to, among the plurality of optical couplers, an optical coupler of which a number of multiplexed signals is same as the number of the plurality of optical transmission devices.

8. The optical communication system according to claim 1, wherein
the controlling circuitry analyzes a total amount of data of the first data signal input to the plurality of optical transmission devices, and outputs, to each of the plurality of optical transmission devices, the first control signal to an effect that in a case where as a result of analysis, the first data signal is multiplexable by, among the plurality of optical couplers, an optical coupler of which a number of multiplexed signals is same as the number of the plurality of optical transmission devices, the first data signal is caused to be transmitted to the optical coupler, and in a case where the first data signal is not multiplexable by the optical coupler, the first data signal is caused to be transmitted to, among the plurality of optical couplers, an optical coupler of which a number of multiplexed signals is smaller than the number of the plurality of optical transmission devices.

9. The optical communication system according to claim 1, wherein
each of the plurality of optical transmission devices and the plurality of optical reception devices stops operation in a time slot in which the packet signal is neither transmitted nor received.

10. A control circuit to control operations of a plurality of optical transmission devices and a plurality of optical reception devices included in an optical communication system including a plurality of optical couplers,
the control circuit analyzing an amount of total optical signals multiplexable by, among the plurality of optical couplers, an optical coupler of which a number of multiplexed signals is smaller than a number of the plurality of optical transmission devices, and outputting, to each of the plurality of optical transmission devices, a first control signal to an effect that in a case where the total optical signals are multiplexable by the optical coupler, the total optical signals are caused to be transmitted to the optical coupler, and in a case where the total optical signals are not multiplexable by the optical coupler, the total optical signals are caused to be transmitted to, among the plurality of optical couplers, an optical coupler of which a number of multiplexed signals is same as the number of the plurality of optical transmission devices.

11. An optical communication method comprising:
a step performed by each of a plurality of optical transmission devices of converting a first data signal that is an electrical signal into a plurality of packet signals as optical signals and transmitting the packet signals;
a step performed by each of a plurality of optical couplers of multiplexing the plurality of packet signals as optical signals transmitted from some optical transmission devices among the plurality of optical transmission devices and the plurality of packet signals as optical signals transmitted from an optical transmission device different from the some optical transmission devices among the plurality of optical transmission devices, and branching a packet signal as an optical signal obtained by multiplexing into a plurality of transmission signals as optical signals including same information and outputting the transmission signals;
a step performed by each of the plurality of optical reception devices of receiving, from the plurality of optical couplers, one of the plurality of transmission signals as optical signals branched by the plurality of optical couplers, and converting the received transmission signal into a second data signal that is an electrical signal and outputting the second data signal; and
a step performed by a controlling circuitry of controlling operations of the plurality of optical transmission devices and the plurality of optical reception devices, wherein
a number of multiplexed signals of some optical couplers among the plurality of optical couplers is smaller than a number of the plurality of optical transmission devices, and
a number of multiplexed signals of remaining optical couplers among the plurality of optical couplers is same as the number of the plurality of optical transmission devices, and
the optical communication method further comprising:
a step performed by each of the plurality of optical transmission devices of allocating a communication resource to a signal to be transmitted so as to prevent the signal to be transmitted from colliding with a packet signal as an optical signal to be transmitted from another optical transmission device on a basis of a first control signal acquired from the controlling circuitry, and transmitting the plurality of packet signals as optical signals; and
a step performed by each of the plurality of optical reception devices of converting the received transmission signal into a transmission signal as an electrical signal, selecting a designated signal portion from the transmission signal as an electrical signal on a basis of a second control signal acquired from the controlling circuitry, and outputting the selected signal portion as the second data signal.
